(19) United States
(12) Patent Application Publication
(10) Pub. No.: US 2014/0129756 A1
(43) Pub. Date: May 8, 2014

(54) DATA PROCESSING DEVICE AND DATA PROCESSING METHOD

(71) Applicant: Fujitsu Limited, Kawasaki-shi (JP)

(72) Inventor: Hiromasa TAKAHASHI, Kawasaki (JP)

(73) Assignee: Fujitsu Limited, Kawasaki-shi (JP)

(21) Appl. No.: 14/025,451

(22) Filed: Sep. 12, 2013

(30) Foreign Application Priority Data
Nov. 6, 2012 (JP) 2012-244840

(51) Int. Cl. G06F 13/40

(52) U.S. Cl. CPC G06F 13/4022
USPC 710/316

(57) ABSTRACT

A data processing device includes: storing units, each configured to store data; data processing units configured to sequentially process the data; and a switch unit configured to couple the storing units to the data processing units, and select a common storing unit from the storing units as a storing unit to be accessed when a first data processing unit of two data processing units out of the data processing units writes the data and a second data processing unit of the two data processing units reads the data, the two data processing units successively processing the data.

### CROSS-REFERENCE TO RELATED APPLICATION

This application is based upon and claims the benefit of priority of the prior Japanese Patent Application No. 2012-244840, filed on Nov. 6, 2012, the entire contents of which are incorporated herein by reference.

### FIELD

A certain aspect of embodiments described herein relates to a data processing device and a data processing method.

### BACKGROUND

There has been known data processing devices that are used in built-in devices and process data by cooperation of multiple processing devices. For example, Japanese Patent Application Publication No. 2006-18514 discloses a data processing device capable of determining whether to pass data through a data buffer among multiple processing devices interconnected by a crossbar switch.

### SUMMARY

According to an aspect of the present invention, there is provided a data processing device including: storing units, each configured to store data; data processing units configured to sequentially process the data; and a switch unit configured to couple the storing units to the data processing units, and select a common storing unit from the storing units as a storing unit to be accessed when a first data processing unit of two data processing units out of the data processing units writes the data and a second data processing unit of the two data processing units reads the data, the two data processing units successively processing the data.

According to an aspect of the present invention, there is provided a data processing method including: selecting a common storing unit from storing units as a storing unit to be accessed when a first data processing unit of two data processing units out of data processing units writes the data and a second data processing unit of the two data processing units reads the data, the data processing units sequentially processing data stored in the storing units, and the two data processing units successively processing the data.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating a configuration of a data processing device in accordance with a comparative example;

FIG. 2 is a diagram illustrating a flow of data among first through third data processing circuits and a processor (time period Ti);

FIG. 3 is a diagram illustrating a flow of data among the first through third data processing circuits and the processor (time period Tj);

FIG. 4 is a timing diagram illustrating processing and passing of data;

FIG. 5 is a configuration diagram illustrating a configuration of a data processing device in accordance with an embodiment;

FIG. 6 is a configuration diagram illustrating a configuration of a data processing device having a different data processing order;

FIG. 7 is a configuration diagram illustrating a configuration of a data processing device in accordance with an alternative embodiment;

FIG. 8 is a configuration diagram illustrating a configuration of an address space of the processor in the comparative example;

FIG. 9 is a configuration diagram illustrating a configuration of an address space of the processor in the alternative embodiment;

FIG. 10 is a timing diagram illustrating processing and passing of data;

FIG. 11 is a configuration diagram illustrating a configuration of a data processing device having a different data processing order;

FIG. 12 is a flowchart illustrating data processing in the comparative example;

FIG. 13 is a flowchart illustrating data processing in the embodiment;

FIG. 14 is a configuration diagram illustrating a connection configuration inside a crossbar switch;

FIG. 15 is a configuration diagram illustrating an alternative connection configuration inside the crossbar switch;

FIG. 16 is a configuration diagram illustrating a connection configuration inside a ring switch;

FIG. 17 is a configuration diagram illustrating an alternative connection configuration inside the ring switch;

FIG. 18 is a diagram illustrating a connection set register inside the switch;

FIG. 19 is a table listing identification numbers of memories;

FIG. 20 is a table listing an example of the setting of the connection set register;

FIG. 21 is a flowchart illustrating a data processing method in accordance with the embodiment;

FIG. 22 is a configuration diagram illustrating a configuration of an image recognition device; and

FIG. 23 is a configuration diagram illustrating a configuration of a radio communication apparatus.

### DESCRIPTION OF EMBODIMENTS

When each of processing devices includes a memory dedicated to storing data to be processed, there may be a problem in data transfer processing between the dedicated memories. For example, the time for and the number of times of the transfer processing affect a processing capacity and electrical power consumption of the data processing device.

The use of a DMA (Direct Memory Access) controller for the data transfer processing reduces the transfer processing time compared to a processor such as a CPU (Central Processing Unit). However, the DMA controller performs the transfer processing under the instruction from the processor and inputs an interrupt input to the processor after completing the transfer processing, and thus the load on the processor increases as the number of times of the transfer processing increases.

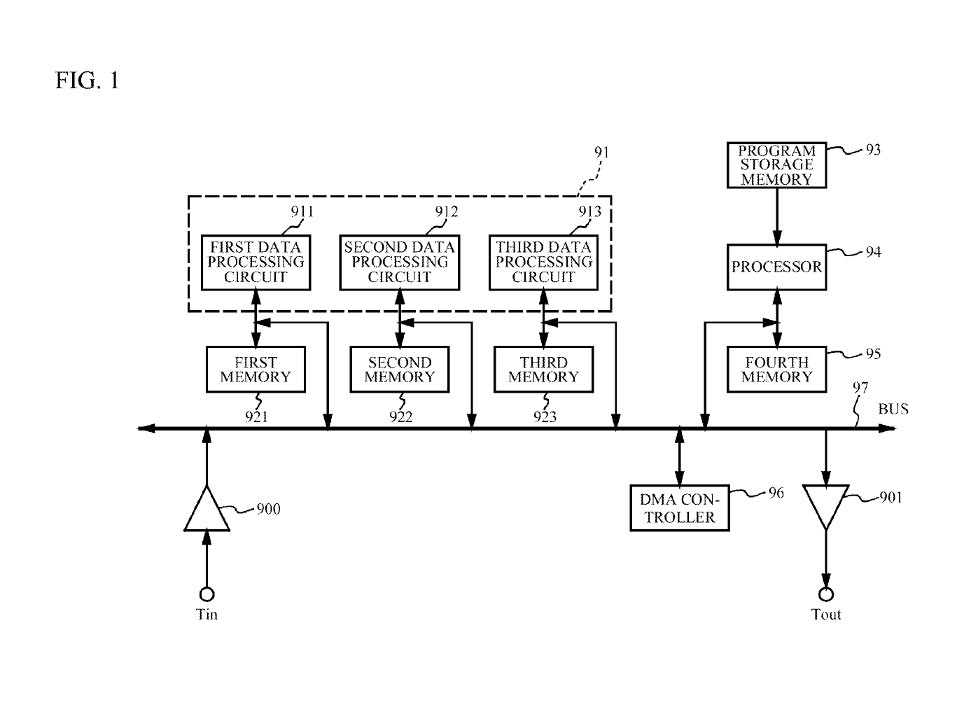

FIG. 1 is a configuration diagram illustrating a configuration of a data processing device in accordance with a comparative example. The data processing device includes an input side buffer 900, an output side buffer 901, a hardware device accelerator 91, and first through third memories 921 to 923. The data processing device further includes a program storage memory 93, a processor 94, a fourth memory 95, a DMA controller 96, and a bus 97.

The hardware device accelerator 91 is a logic circuit that operates without using software, and includes first through third data processing circuits 911 to 913 having individual data processing functions. The first through third data processing circuits 911 to 913 are hardwired logics suitable for the respective data processing functions. The first through third data processing circuits 911 to 913 are coupled to the dedicated first through third memories 921 to 923, respectively. The first through third data processing circuits 911 to 913 and the first through third memories 921 to 923 are coupled to the bus 97 through respective connection lines.

The processor 94 is an arithmetic processing circuit that operates in accordance with software, i.e. programs, and is a CPU or DSP (Digital Signal Processor) for example. A program that makes the processor 94 operate is stored in the program storage memory 93 coupled to the processor 94.

The program storage memory 93 is, for example, an SRAM (Static Random Access Memory). The processor 94 reads a program from a boot ROM (Read Only Memory) located inside or outside the data processing device and stores it in the program storage memory 93 at the time of power-on or reset.

The processor 94 is coupled to the fourth memory 95 that functions as a working memory. The processor 94 and the fourth memory 95 are coupled to the bus 97 through a connection line therebetween. Examples of the first through fourth memories 921 to 923, 95 include, but are not limited to, an SRAM (Static RAM), and may be a DRAM (Dynamic RAM) or other storing units that store data (e.g. a memory card or a hard disk drive).

The input side buffer 900 stores data input from an input terminal Tin, and the stored data is output to the bus 97. Each of the first through fourth memories 921 to 923, 95 has an individual storage area that stores data. The first through third data processing circuits 911 to 913 and the processor 94 individually access the first through fourth memories 921 to 923, 95 to read and write data.

The first through third data processing circuits 911 to 913 and the processor 94 cooperate to sequentially process data. In the present example, the first data processing circuit 911, the second data processing circuit 912, the third data processing circuit 913, and the processor 94 sequentially process the data in this order. The processing order may be changed in accordance with data processing contents.

The data on which all the processes are performed is input from the bus 97 to the output side buffer 901 and stored. The data stored in the output side buffer 901 is output to the outside through the output terminal Tout.

As described above, electrical power consumption is reduced as well as a processing speed is increased by performing a part of the processes by the hardware device accelerator 91 instead of performing all the processes by only the processor 94.

In addition, the hardware device accelerator 91 can integrate processing functions achieved by multiple processors 94 and reduce the number of necessary processors 94, and the area of a chip is therefore reduced when the data processing device is produced as a single-chip device. Further, the function can be changed by updating a program that makes the processor 94 operate, and thus an upgrade in future is flexibly supported. The exemplary application of the data processing device is an image recognition device and a radio communication apparatus as described later.

As described above, the first through third data processing circuits 911 to 913 and the processor 94 respectively have the first through fourth memories 921 to 923, 95, and thus access only their own memories 921 to 923, 95 respectively. For example, the first data processing circuit 911 can access the first memory 921, but cannot access the second through fourth memories 922, 923, 95. That is to say, the data processing device of the comparative example has certain restrictions on access to the first through fourth memories 921 to 923, 95 from the first through third data processing circuits 911 to 913 and the processor 94.

Therefore, the first through third data processing circuits 911 to 913 and the processor 94 sequentially pass data by data transfer among the memories 921 to 923, 95. The DMA controller 96 transfers data among the memories 921 to 923, 95 through the bus 97 in accordance with flow control from the processor 94.

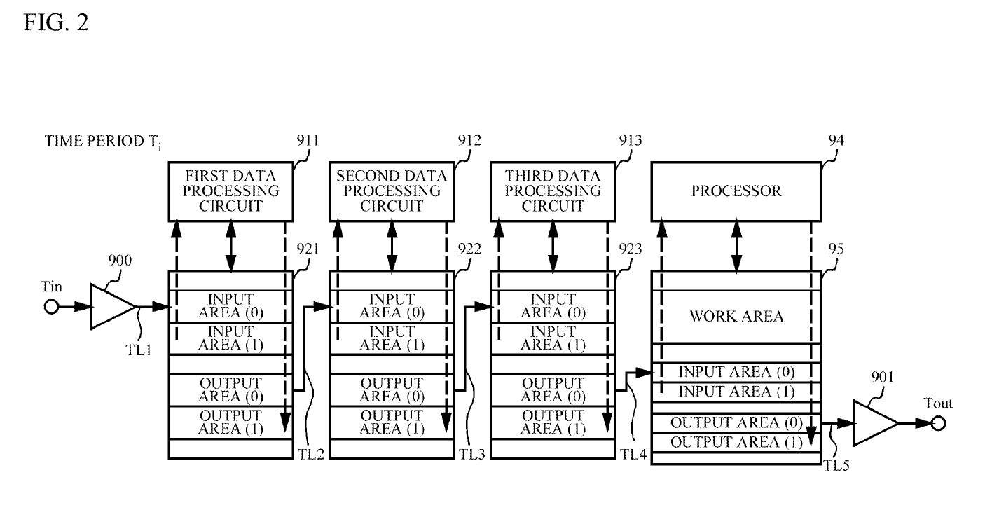

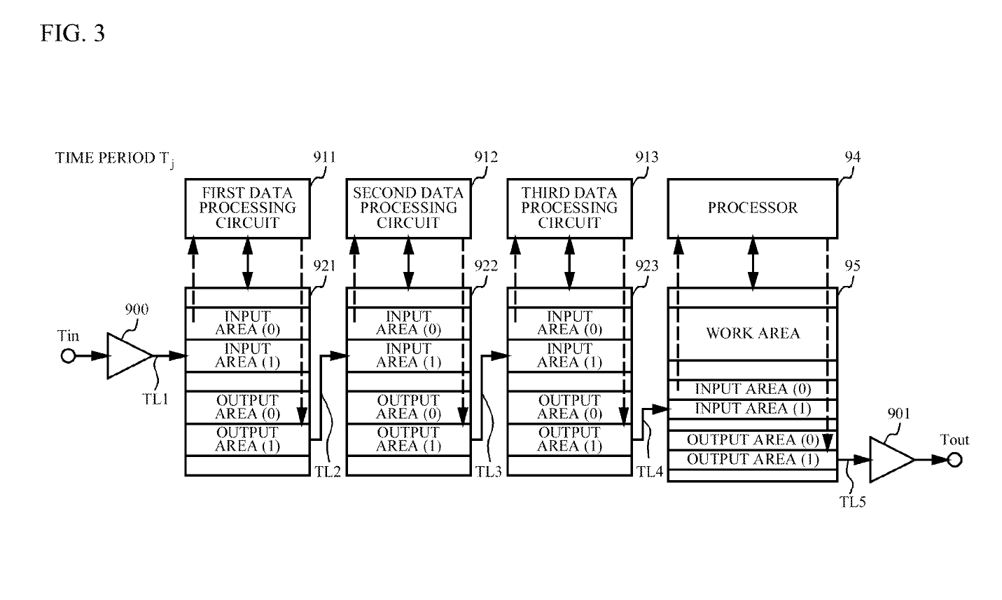

FIG. 2 and FIG. 3 illustrate a flow of data among the first through third data processing circuits 911 to 913 and the processor 94. FIG. 2 illustrates the flow of data during time period Ti and FIG. 3 illustrates the flow of data during time period Tj, time periods Ti and Tj alternately coming. Reference numerals TL1 to TL5 represent data transfer processing by the DMA controller 96.

In the present example, each of the first through fourth memories 921 to 923, 95 has two input areas (0), (1) and two output areas (0), (1). The fourth memory 95 further has a work area for the processor 94.

Each of the two input areas (0), (1) stores data waiting to be processed (unprocessed data) of the first through third data processing circuits 911 to 913 and the processor 94. On the other hand, each of the two output areas (0), (1) stores processed data of the first through third data processing circuits 911 to 913 and the processor 94. Two input areas (0), (1) may have the same capacity as or different capacities from the two output areas (0), (1).

The two input areas (0), (1) and the two output areas (0), (1) function as a storage area having a double surface structure referred to as a double buffer. That is to say, data is written to a first area of the two areas while data is read from a second area of the two areas during time period Ti, and data is written to the second area while data is read from the first area during time period Tj. This prevents errors from occurring in data because of collision between data writing and data reading.

During time period Ti (see FIG. 2), data input from the input terminal Tin to the input side buffer 900 is written to the input area (0) of the first memory 921 by the transfer processing TL1. On the other hand, data waiting to be processed that was stored in the input area (1) of the first memory 921 during the last time period (time period Tj) is read out and processed by the first data processing circuit 911, and the processed data is written to the output area (1) of the first memory 921. The data waiting to be processed and the processed data of the first through third data processing circuits 911 to 913 and the processor 94 may have the same size (data volume) or different sizes.

Processed data that was stored in the output area (0) of the first memory 921 during the last time period (time period Tj) is written to the input area (0) of the second memory 922 by the transfer processing TL2. On the other hand, data waiting to be processed that was stored in the input area (1) of the second memory 922 during the last time period (time period Tj) is read out and processed by the second data processing circuit 912, and the processed data is written to the output area (1) of the second memory 922.

Processed data that was stored in the output area (0) of the second memory 922 during the last time period (time period Tj) is written to the input area (0) of the third memory 923 by the transfer processing TL3. On the other hand, data waiting to be processed that was stored in the input area (1) of the third memory 923 during the last time period (time period Tj) is read out and processed by the third data processing circuit 913, and the processed data is written to the output area (1) of the third memory 923.

Processed data that was stored in the output area (0) of the third memory 923 during the last time period (time period Tj) is written to the input area (0) of the fourth memory 95 by the transfer processing TL4. On the other hand, data waiting to be processed that was stored in the input area (1) of the fourth memory 95 during the last time period (time period Tj) is read out and processed by the processor 94, and written to the output area (1) of the fourth memory 95.

Processed data that was stored in the output area (0) of the fourth memory 95 during the last time period (time period Tj) is written to the output side buffer 901 by the transfer processing TL5, and output to the outside through an output terminal Tout. In addition, during the time period Tj (FIG. 3), the operation is performed with the input areas (0) and (1) being alternated and the output areas (0) and (1) being alternated. As described above, the data undergoes five times of the transfer processing TL1 to TL5 from the time of input to the data processing device until the time of output therefrom.

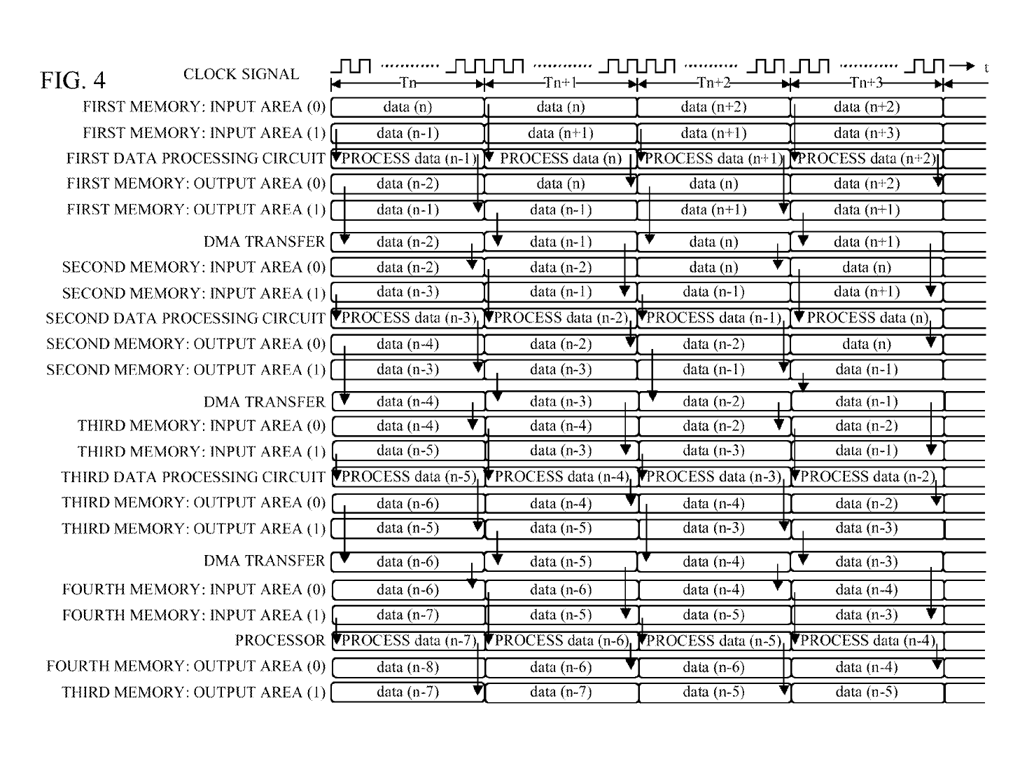

FIG. 4 is a timing diagram illustrating processing and passing of data. In FIG. 4, “data (x)” (x is a natural number) represents data input from the outside to the data processing device during time period Tx. Time period Tx changes to Tn, Tn+1, Tn+2 . . . in synchronization with a clock signal in the data processing device. Here, time periods Tn, Tn+2 . . . correspond to the above described time period Ti, and time periods Tn+1, Tn+3 . . . correspond to the above described time period Tj.

The columns of “FIRST DATA PROCESSING CIRCUIT” to “THIRD DATA PROCESSING CIRCUIT” indicate data to be processed by the first through third data processing circuits 911 to 913 respectively during time period Tx, and the column of “PROCESSOR” indicates data to be processed by the processor 94 during time period Tx. The columns of “INPUT AREAS (0), (1)” and “OUTPUT AREAS (0), (1)” of “FIRST MEMORY” to “FOURTH MEMORY” indicate data stored in the areas of the first through fourth memories 921 to 923, 95 during time period Tx. The column of “DMA TRANSFER” indicates data to be transferred. Arrows connecting data indicate a move of data.

The first through third data processing circuits 911 to 913 and the processor 94 sequentially pass data (x) that is input at each time period Tx by the transfer processing TL1 to TL5 among the first through fourth memories 921 to 923, 95. The number of times of the transfer processing TL1 to TL5 affects the processing capacity and the electrical power consumption of the data processing device.

In addition, the processor 94 outputs an instruction to the DMA controller 96 at every transfer processing TL1 to TL5, and receives an interrupt input from the DMA controller 96, the interrupt input indicating completion of the transfer. Therefore, the number of times of the transfer processing TL1 to TL5 defines complexity of the flow control of the processor 94 and affects the load on the processor 94.

Further, the input areas (0), (1) and the output areas (0), (1) of each of the first through fourth memories 921 to 923, 95 store data (x) that is the same data before and after the transfer processing TL1 to TL5 during the same time period Tx. Therefore, the number of times of the transfer processing TL1 to TL5 affects a whole capacity of the storage area of the memories 921 to 923, 95.

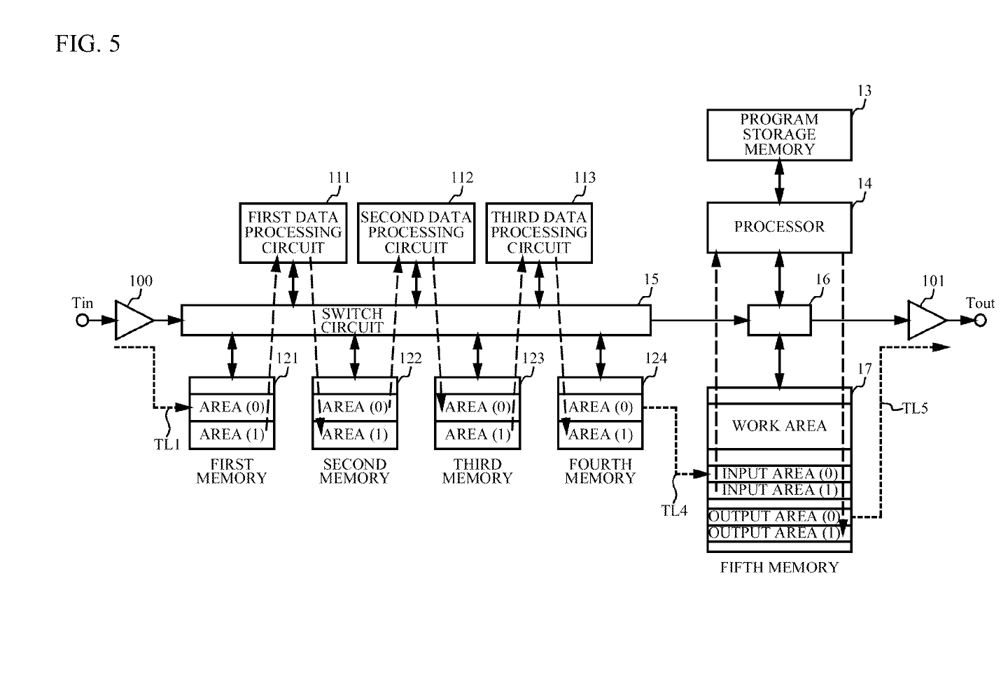

A data processing device of an embodiment relaxes the restriction on access to the memory from the data processing circuits 911 to 913, and thus reduces the number of times of data transfer. FIG. 5 is a configuration of the data processing device in accordance with the embodiment.

The data processing device includes an input side buffer 100, an output side buffer 101, first through third data processing circuits (data processing units) 111 to 113, first to fourth memories (storing units) 121 to 124, and a program storage memory 13. The data processing device further includes a processor 14, a first switch circuit (switch unit) 15, a second switch circuit 16, and a fifth memory 17.

The first through third data processing circuits 111 to 113 and the processor 14 cooperate to sequentially process data as those of the comparative example do. The first data processing circuit 111, the second data processing circuit 112, the third data processing circuit 113, and the processor 14 sequentially process data in this order. The first through third data processing circuits 111 to 113 are hardware device accelerators same as the first through third data processing circuits 911 to 913.

The first through fourth memories 121 to 124 have their own storage areas to store data. The storage area includes two areas (0), (1) functioning as a double buffer described above. That is to say, data writing to one of the two areas (0), (1) and data reading from the other one are alternated at time intervals. This prevents errors from occurring in data because of collision between data writing and data reading.

The first switch circuit 15 couples the first through fourth memories 121 to 124 to the first through third data processing circuits 111 to 113, and selects memories to be accessed by the first through third data processing circuits 111 to 113 from the first through fourth memories 121 to 124. This allows, unlike the comparative example, the first through third data processing circuits 111 to 113 to access multiple memories without restricting an accessible memory to a specific memory.

The configuration of the first switch circuit 15 will be described later.

The program storage memory 13 stores a program that makes the processor 94 operate as with the above described program storage memory 93. The second switch circuit 16 has the same function as the first switch circuit 15, and couples the processor 94 to the fifth memory 17. The fifth memory 17 has two input areas (0), (1), two output areas (0), (1), and a work area as with the above described fourth memory 95.

In addition, dotted arrows in FIG. 5 represent a flow of data during a first period of time periods that alternately come (corresponding to Ti and Tj described above). The transfer processing TL1, TL4, TL5 correspond to the transfer processing TL1, TL4, TL5 in the comparative example respectively.

The input side buffer 100 stores data input from the input terminal Tin. The stored data is written to the area (0) of the first memory 121 by the transfer processing TL1 by the DMA controller. The DMA controller may be located outside the data processing device or inside the switch circuit 15.

Data waiting to be processed that was stored in the area (1) of the first memory 121 during the last time period (a second time period of the alternately coming time periods) is read out and processed by the first data processing circuit 111 through the first switch circuit 15. The processed data is written to the area (1) of the second memory 122 by the first data processing circuit 111 through the first switch circuit 15.

Data waiting to be processed that was stored in the area (0) of the second memory 121 during the last time period is read out and processed by the second data processing circuit 112 through the first switch circuit 15. The processed data is written to the area (0) of the third memory 123 by the second data processing circuit 112 through the first switch circuit 15.

Data that was stored in the area (1) of the third memory 123 during the last time period is read out and processed by the third data processing circuit 113 through the first switch circuit 15. The processed data is written in the area (1) of the fourth memory 124 by the third data processing circuit 113 through the first switch circuit 15.

Data that was stored in the area (0) of the fourth memory 124 during the last time period is written to the input area (0) of the fifth memory 17 through the first and second switch circuits 15, 16 by the transfer processing TL4 by the DMA controller. On the other hand, data that was stored in the input area (1) of the fifth memory 17 during the last time period is read out and processed by the processor 14 through the second switch circuit 16, and the processed data is written to the output area (1) of the fifth memory 17.

Data that was stored in the output area (0) of the fifth memory 17 during the last time period is input to and stored in the output side buffer 101 through the second switch circuit 16 by the transfer processing TL5 by the DMA controller. The data stored in the output side buffer 101 is output to the outside through the output terminal Tout. During the second time period, the operation is performed with the areas (0) and (1) of the first to fourth memories 121 to 124 being alternated and the input areas (0) and (1) of the fifth memory 17 being alternated and the output areas (0) and (1) thereof being alternated.

In the above described operation, the switch circuit 15 selects a common memory from the memories 121 to 124 as a memory to be accessed when one of two data processing circuits, which successively process data, of the data processing circuits 111 to 113 writes data and the other one reads out data. Thus, the first through third data processing circuits 111 to 113 can access the common memories 122, 123 through the first switch circuit 15 and sequentially pass data through the storage area thereof.

For example, the first data processing circuit 111 accesses the second memory 122 and writes processed data thereinto, and the second data processing circuit 112 also accesses the second memory 122 and reads data waiting to be processed therefrom. In addition, the second data processing circuit 112 accesses the third memory 123 and writes processed data thereinto, and the third data processing circuit 113 also accesses the third memory 122 and reads data waiting to be processed therefrom.

Thus, the present embodiment enables, unlike the comparative example, to pass data through a common storage area (areas (0), (1)) without separately providing an input area and an output area to the first through fourth memories 121 to 124. Therefore, the capacity of the whole storage area is reduced, and the number of times of the data transfer processing among the first through fourth memories 121 to 124 is reduced. Compared to the comparative example, eliminated is two transfer processing TL2, TL3 out of the data transfer processing TL1 to TL5 illustrated in FIG. 2. Accordingly, the present embodiment also reduces electrical power consumption.

As described above, the first through third data processing circuits 111 to 113 are coupled to the first through fourth memories 121 to 124 through the first switch circuit 15, and thus can access multiple memories. Therefore, the present embodiment can flexibly change a data processing order by changing a memory to be accessed by the first through third data processing circuits 111 to 113.

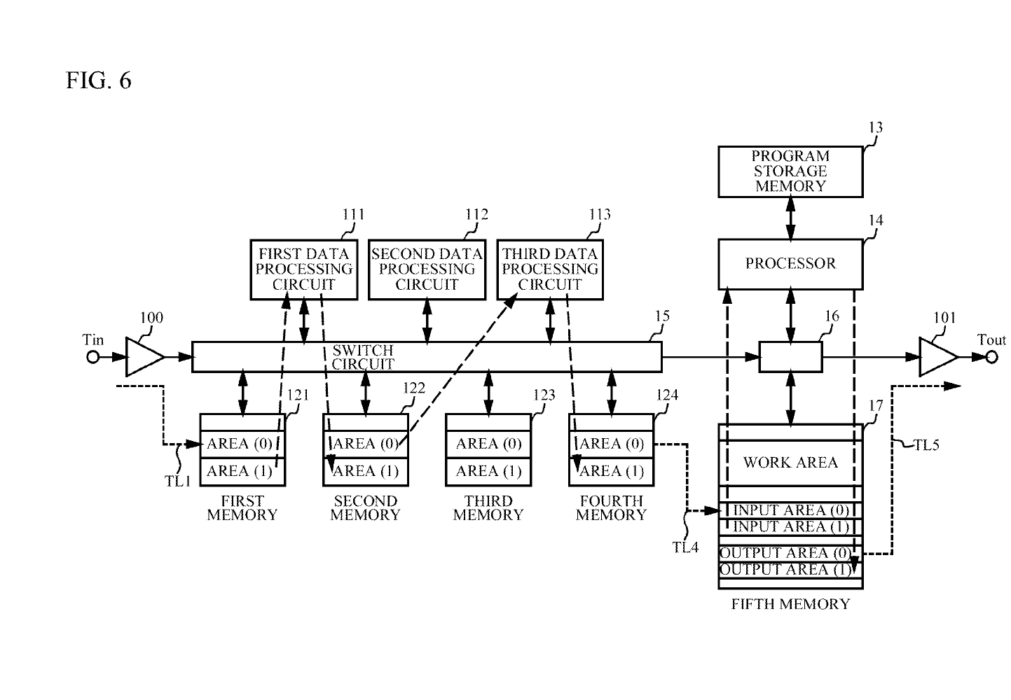

FIG. 6 illustrates a configuration of a data processing device having a different data processing order. In the present example, the data processing device processes data by only the first and third data processing circuits 111, 113 and the processor 14. Therefore, the second memory 122 is used to pass data among the first and third data processing circuits 111, 113, and the third memory 123 is not used.

Memories to be accessed by the first and third data processing circuits 111, 113 may be configured by using a connection set register described later. Thus, in the present example, data may be passed through the third memory 123 instead of the second memory 122. As described above, the use of the switch circuit 15 relaxes the restriction on access to the memories 121 to 124, and the first through fourth memories 121 to 124 can be shared by the first through third data processing circuits 111 to 113.

In the present embodiment, the fifth memory 17 is coupled to the processor 14 through the second switch circuit 16 different from the first switch circuit 15 to which the first to fourth memories 121 to 124 are coupled. Thus, performed is the data transfer processing TL4 from the fourth memory 124 to the fifth memory 17.

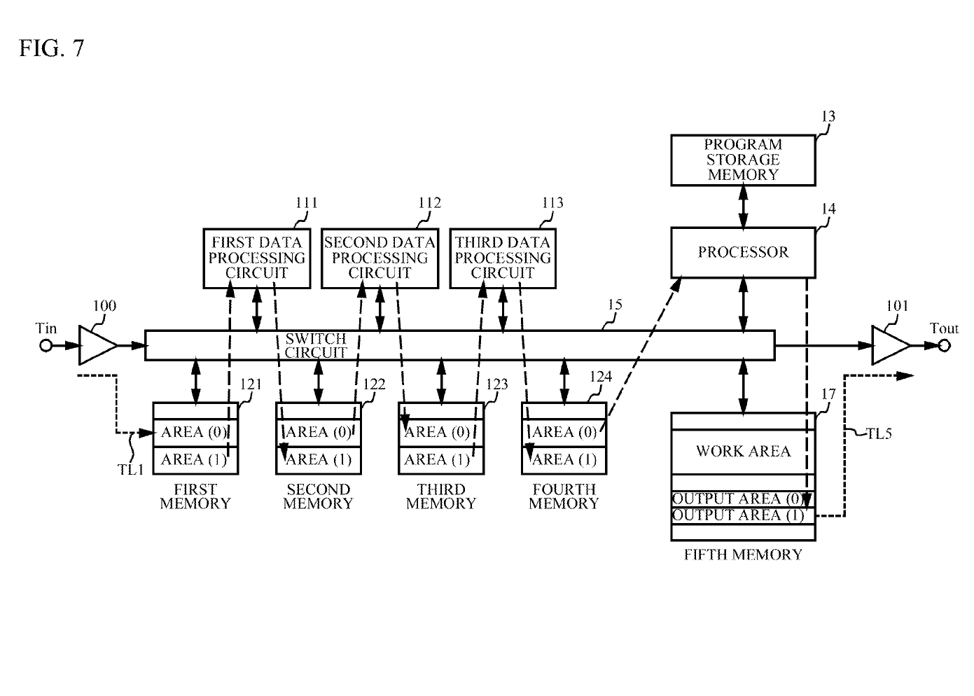

To eliminate the transfer processing TL4, the processor 14 and the fifth memory 17 may be coupled to the switch circuit 15, and the fifth memory 17 may be shared. FIG. 7 is a configuration diagram illustrating a configuration of a data processing device in accordance with an alternative embodiment. In FIG. 7, the same reference numerals are affixed to the components same as those illustrated in FIG. 5, and the description thereof is omitted.

In the present embodiment, the switch circuit 15 couples the first through third data processing circuits 111 to 113 and the processor (data processing unit) 14 to the first to fifth memories 121 to 124, 17. The switch circuit 15 selects a memory to be accessed by the first through third data processing circuits 111 to 113 and the processor 14 from the first through fifth memories 121 to 124, 17.

The processor 14 has an address space determined by the settings of the boot ROM unlike the first through third data processing circuits 111 to 113. Thus, the change of the address space allows the processor 14 to access the first through fourth memories 121 to 124.

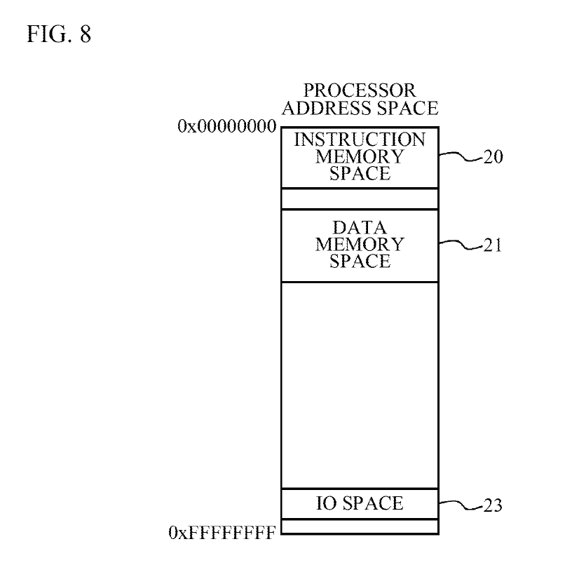

FIG. 8 is a configuration diagram illustrating a structure of the address space of the processor 94 in the comparative example. The address space has addresses of 0x00000000 to 0xFFFFFFFF when the processor 94 is a 32 (bit) CPU for example. The address space includes an instruction memory space 20, a data memory space 21, and an IO (Input and Output) space 23.

The instruction memory space 20 is a space allocated to the program storage memory 93. The data memory space 21 is a space allocated to the fourth memory 95 including a work area. In addition, the IO space 23 is a space allocated to an external input/output device such as a DMA controller.

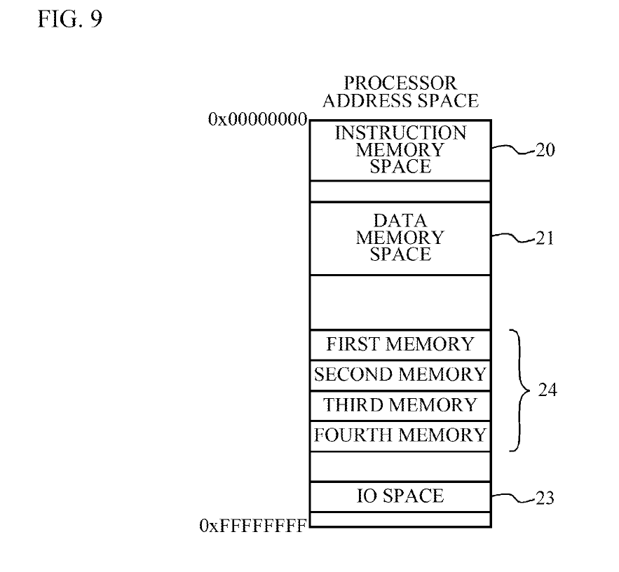

On the other hand, FIG. 9 is a configuration diagram illustrating a structure of an address space of the processor 14 in the present embodiment. The address space includes a memory space 24 allocated to the first through fourth memories 121 to 124 in addition to the above described instruction memory space 20, the data memory space 21, and the IO space 23. As described above, the allocation of the storage areas of the first through fourth memories 121 to 124 to the address space of the processor 14 allows the processor 14 to access the first through fourth memories 121 to 124.

Therefore, the processor 14 can directly read data from the fourth memory 124. In addition, unlike the previous embodiment, the fifth memory (storing unit) 17 does not have an input area and has only the two output areas (0), (1) and the work area.

The dotted arrows in FIG. 7 represent a flow of data during a first time period of alternately coming time periods (correspond to Ti, Tj described above). The process from when data is input to the input side buffer 100 till the third data processing circuit 113 writes the processed data to the area (1) of the fourth memory 124 is as described by referring to FIG. 5.

Data waiting to be processed that was stored in the area (0) of the fourth memory 124 during the last time period (a second time period of the alternately coming time periods) is read out and processed by the processor 14 through the switch circuit 15. The processed data is written to the output area (0) of the fifth memory 17 by the processor 14 through the switch circuit 15. At this point, the processor 14 performs reading, processing, and writing of data in parallel.

Processed data that was stored in the output area (1) of the fifth memory 17 during the last time period is input to and stored in the output side buffer 101 through the switch circuit 15 by the transfer processing TL5 by the DMA controller. The stored data in the output side buffer 101 is output to the outside through the output terminal Tout. As described above, the present embodiment can additionally eliminate the transfer processing TL4. During the second time period, performed is the operation with the areas (0) and (1) being alternated and the output areas (0) and (1) being alternated.

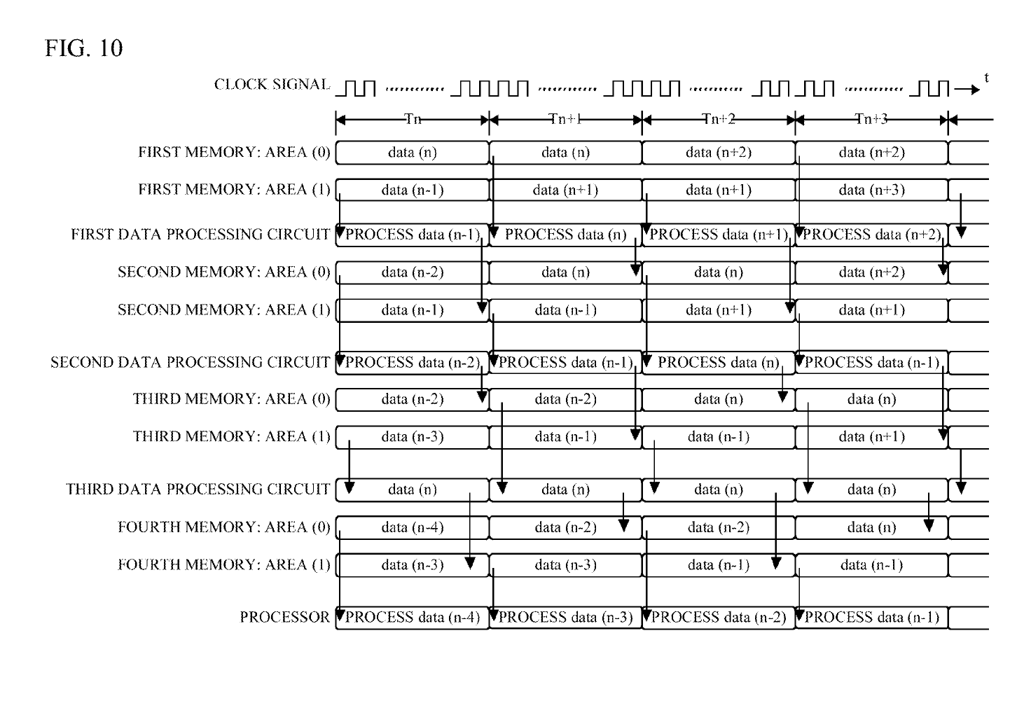

FIG. 10 is a timing diagram illustrating processing and passing of data in the present embodiment. The descriptions in FIG. 10 are the same as those in FIG. 4. Comparison between FIG. 10 and FIG. 4 demonstrates that the present embodiment does not perform the data transfer processing by the DMA controller at all from when data is written to the first a memory till the data is processed by the processor 14 and written to the first memory. Therefore, the present embodiment can reduce the number of times of the data transfer more than the embodiment illustrated in FIG. 5.

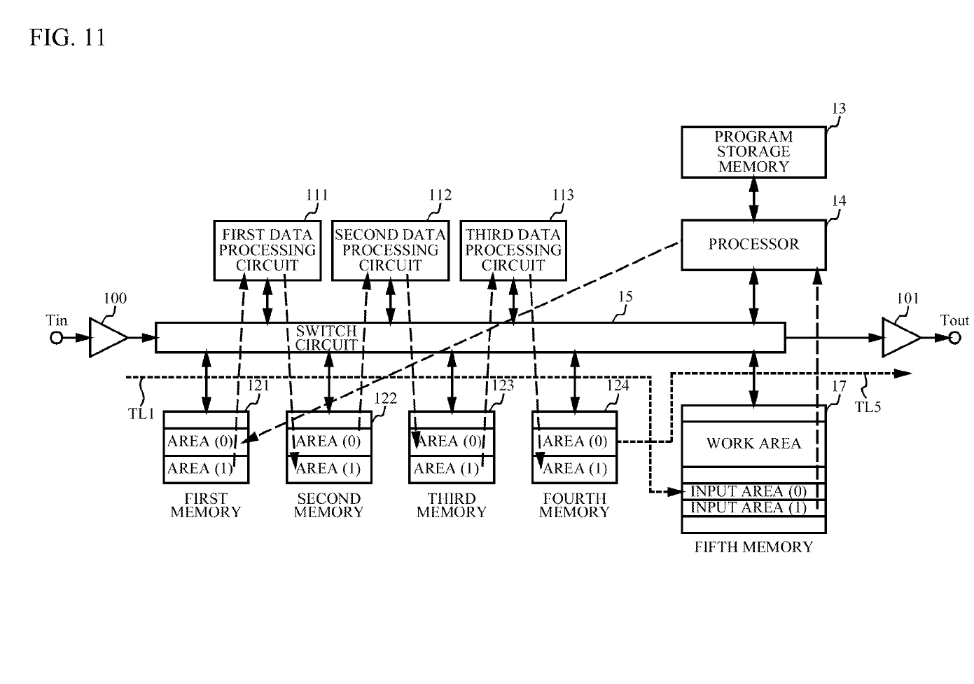

In addition, the data processing order is not limited either in the present embodiment. FIG. 11 is a configuration diagram illustrating a configuration of a data processing device having a different data processing order. In FIG. 11, the dotted arrows represent a flow of data. In the present example, the processor 14, the first data processing circuit 111, the second data processing circuit 112, and the third data processing circuit 113 sequentially process data in this order. As described above, the switch circuit 15 enables to flexibly change the data processing order.

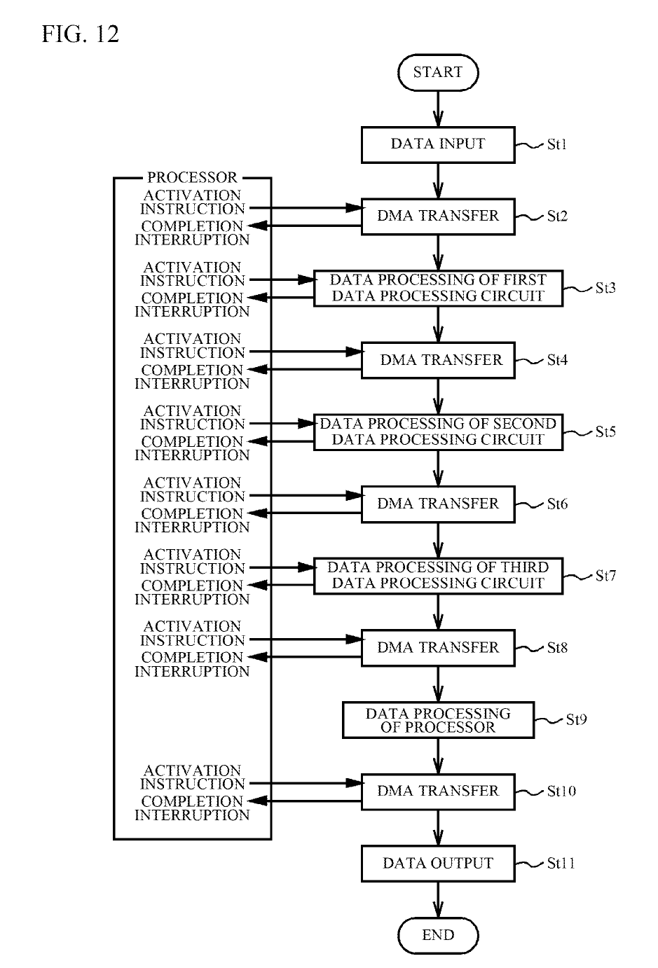

A description will be given of a load on the processor 14 in the present embodiment. FIG. 12 is a flowchart illustrating data processing in the comparative example. The input and output processes to the processor 94 at each step in the flow are illustrated at the left side in FIG. 12.

First, data is input to the input side buffer 900 from the outside of the data processing device (step St1). The DMA controller 96 then transfers the data to the first memory 921 according to an activation instruction from the processor 94, and outputs completion interruption to the processor 94 after the completion of the transfer (step St2). Then, the first data processing circuit 911 processes the data according to an activation instruction from the processor 94, and outputs completion interruption to the processor 94 after the completion of the processing (step St3).

The DMA controller 96 then transfers the data to the second memory 922 according to an activation instruction from the processor 94, and outputs completion interruption to the processor 94 after the completion of the transfer (step St4). Then, the second data processing circuit 912 processes the data according to an activation instruction from the processor 94, and outputs completion interruption to the processor 94 after the completion of the processing (step St5).

The DMA controller 96 then transfers the data to the third memory 923 according to an activation instruction from the processor 94, and outputs completion interruption to the processor 94 after the completion of the transfer (step St6). Then, the third data processing circuit 913 processes the data according to an activation instruction from the processor 94, and outputs completion interruption to the processor 94 after the completion of the processing (step St7).

The DMA controller 96 then transfers the data to the fourth memory 95 according to an activation instruction from the processor 94, and outputs completion interruption to the processor 94 after the completion of the transfer (step St8). Then, the processor 94 processes the data (step St9). The DMA controller 96 then transfers the data to the output side buffer 901 according to an activation instruction from the processor 94, and outputs completion interruption to the processor 94 after the completion of the transfer (step St10). The data on which all the processes are performed is output to the outside of the data processing device through the output terminal Tout (step St11).

As described above, the processor 94 sends the activation instruction to the DMA controller 96 five times, and receives the completion interruption from the DMA controller 96 five times. In addition, the processor 94 sends the activation instruction to the data processing circuits 911 to 912 three times, and receives the completion interruption from the data processing circuits 911 to 912 three times. Therefore, the processor 94 performs the flow control 16 times.

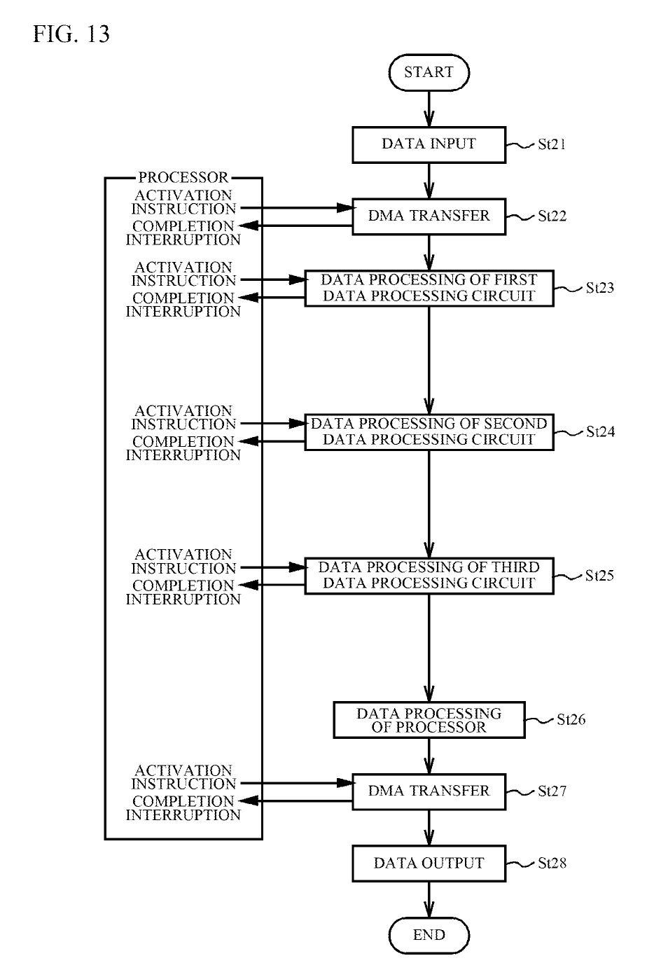

On the other hand, FIG. 13 is a flow chart illustrating data processing in the embodiment illustrated in FIG. 7. First, data is input to the input side buffer 100 from the outside of the data processing device (step St21). The DMA controller then transfers the data to the first memory 121 according to an activation instruction from the processor 14, and outputs completion interruption to the processor 14 after the completion of the transfer (step St22).

The first data processing circuit 111 then processes the data according to an activation instruction from the processor 14, and outputs completion interruption to the processor 14 after the completion of the processing (step St23). Then, the second data processing circuit 112 processes the data according to an activation instruction from the processor 14, and outputs completion interruption to the processor 14 after the completion of the processing (step St24). Then, the third data processing circuit 113 processes the data according to an activation instruction from the processor 14, and outputs completion interruption to the processor 14 after the completion of the processing (step St25).

Then, the processor 14 processes the data (step St26). The DMA controller then transfers the data to the output side buffer 101 according to an activation instruction from the processor 14, and outputs completion interruption to the processor 14 after the completion of the transfer (step St27). The data on which all the processes are performed is output to the outside of the data processing device through the output terminal Tout (step St28).

As described above, the processor 14 sends the activation instruction to the DMA controller twice, and receives the completion interruption from the DMA controller twice. In addition, the processor 14 sends the activation instruction to the data processing circuits 111 to 112 three times, and receives the completion interruption from the data processing circuits 111 to 112 three times. Therefore, the processor 14 performs the flow control 10 times.

Comparison between FIG. 12 and FIG. 13 demonstrates that the data processing device of the present embodiment performs data transfer processing less than the comparative example, and the number of executions of the flow control by the processor 14 is therefore less. Thus, the load for the flow control on the processor 14 is reduced, and the reduction of the load allows the processor 14 to use the remaining processing capacity for other processes.

Especially, the completion interruption occurs in asynchronization with the process of the processor 14, and the execution of a process by the processor 14 is thus interrupted by the completion interruption regardless of the processing state. Therefore, the reduction of the number of executions of the completion interruption allows the processor 14 to have more processing capacity.

As described above, the first through fifth memories 121 to 124, 17 individually store data, and the data processing circuits 111 to 113 and the processor 14 sequentially process data.

The switch circuit 15 couples the first through fifth memories 121 to 124, 17 with the first through third data processing circuits 111 to 113 and the processor 14. The switch circuit 15 selects a common memory from the memories 121 to 124, 17 as a memory to be accessed when one of two, which successively process data, of the data processing circuits 111 to 113 and the processor 14 writes data and the other one reads data.

Thus, the data processing device of the embodiment allows the data processing circuits 111 to 113 and the processor 14 to sequentially pass data among the first through fifth memories 121 to 124, 17 without performing the data transfer processing by the DMA controller. Therefore, the data processing device of the embodiment reduces a load of data transfer processing.

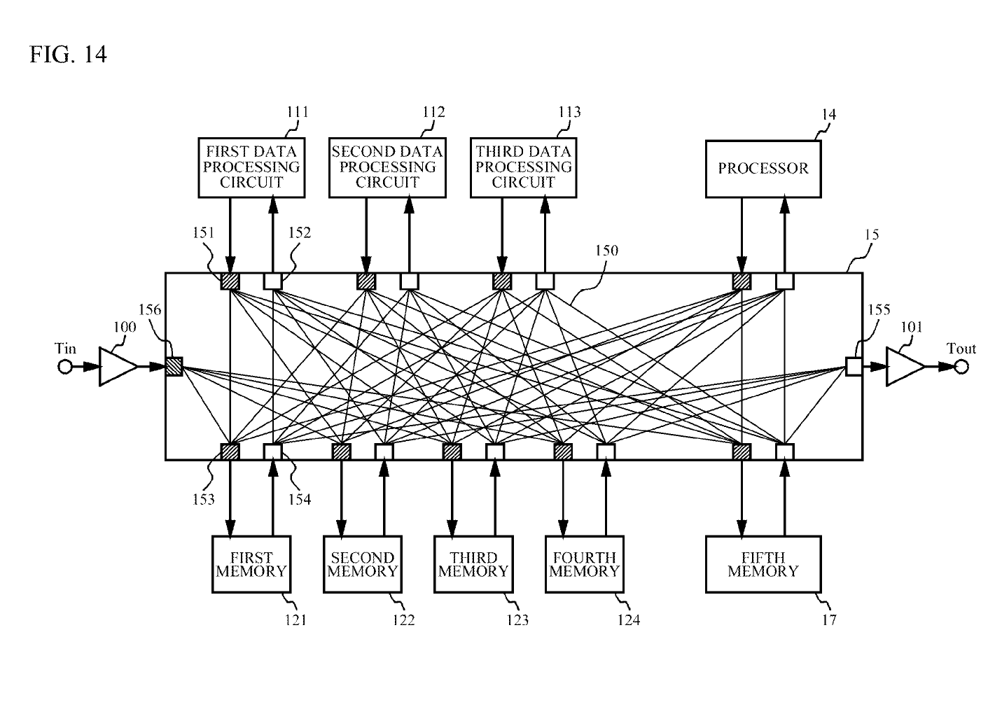

A description will next be given of configurations of the switch circuit 15 used in the data processing device with use of examples of a crossbar switch and a ring switch. FIG. 14 is a configuration diagram illustrating a connection configuration inside a crossbar switch.

The switch circuit 15 includes connecting lines 150, first input ports 151, first output ports 152, second output ports 153, second input ports 154, a third input port 156, and a third output port 155. The third input port 156 and the third output port 155 are coupled to the input side buffer 100 and the output side buffer 101 respectively.

The first input ports 151 and the first output ports 152 are coupled to the first through third data processing circuits 111 to 113 and the processor 14. The first input ports 151 receive one of or both the addresses and data of the memories 121 to 124, 17 from the first through third data processing circuits 111 to 113 and the processor 14. The first output ports 152 output data to the first through third data processing circuits 111 to 113 and the processor 14.

In addition, the second input ports 154 and the second output ports 153 are coupled to the first through fifth memories 121 to 124, 17. The second input ports 154 receive data from the first through fifth memories 121 to 124, 17. The second output ports 153 output one of or both the address and data to the respective first through fifth memories 121 to 124, 17.

The connecting lines 150 interconnect the ports 151 to 156 inside the switch circuit 15. In the present example, the connecting lines 150 connect each of the first input ports 151 to all the second output ports 153, and connect each of the first output ports 152 to all the second input ports 154. In addition, the connecting lines 150 connect the third input port 156 to all the second output ports 153, and connect a third output port 157 to all the second input ports 154. As described above, the switch circuit 15 has a network interconnecting the ports 151 to 156.

The first through third data processing circuits 111 to 113 allocate, unlike the processor 14, the same address to the areas (0), (1) of the first through fourth memories 121 to 124. That is to say, the areas (0), (1) of the first through fourth memories 121 to 124 have the same address with respect to the first through third data processing circuits 111 to 113. Thus, even when the data processing order is changed, the address from which data is read and the address to which data is written are not changed, and thus the first through third data processing circuits 111 to 113 can flexibly respond to the change of the data processing order.

Therefore, the first input ports 151 and the first output ports 152 coupled to the first through third data processing circuits 111 to 113 select a to-be-communicated port from the second output ports 153 and the second input ports 154 in accordance with not the address but the individual connection settings.

For example, the selected second input port 154 outputs data to the first output port 152 when data is read, while the first input port 151 outputs the address and data to the selected second output port 153 when data is written. This allows the first through third data processing circuits 111 to 113 to access a memory selected from the first through fourth memories 121 to 124 in accordance with the data processing order. The individual connection settings of the first input ports 151 will be described later.

On the other hand, the processor 14 allocates different addresses to the first through fourth memories 121 to 124 as illustrated in FIG. 9. Thus, the first input port 151 coupled to the processor 14 selects, based on the address, the second output port 153 that is to be a destination. The third input port 156 may determine a destination port based on any of the connection settings and the address.

As described above, the switch circuit 15 of the present example couples the first through third data processing circuits 111 to 113 and the processor 14 to the first through fifth memories 121 to 124, 17 so that the first through third data processing circuits 111 to 113 and the processor 14 can access any of the first through fifth memories 121 to 124, 17. Therefore, the degree of freedom of connection between the first through third data processing circuits 111 to 113 and the processor 14 and the first through fifth memories 121 to 124, 17 is high, and the data processing order can be flexibly changed.

In the switch circuit 15 of the present example, the connecting lines 150 separately interconnect the ports 151 to 156. Therefore, the first through third data processing circuits 111 to 113 and the processor 14 can access the first through fifth memories 121 to 124, 17 without being interrupted by the access of the other processing circuits. Thus, the switch circuit 15 of the present example reduces the waiting time for access, and shortens the time required to access.

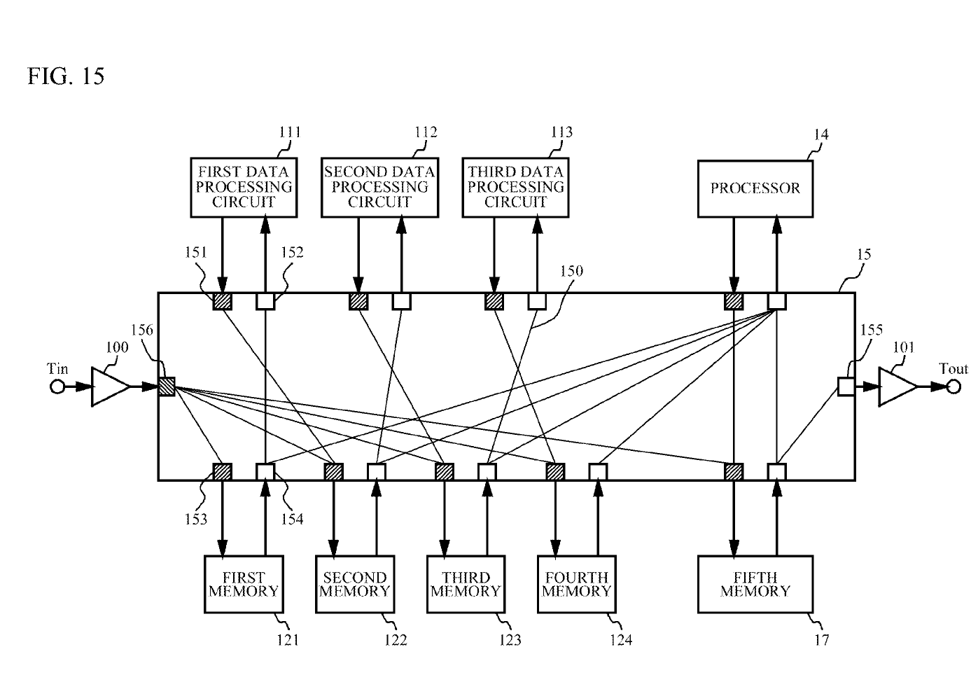

The switch circuit 15 of the present example includes a number of connecting lines 150, but the number of the connecting lines 150 may be reduced. FIG. 15 illustrates an alternative connection configuration inside the crossbar switch.

The switch circuit 15 of the present example couples the first through third data processing circuits 111 to 113 and the processor 14 to the first through fifth memories 121 to 124, 17 so that the first through third data processing circuits 111 to 113 and the processor 14 can access a memory to be accessed out of the first through fifth memories 121 to 124, 17 in accordance with the data processing order. More specifically, the connection configuration of the present example is based on the data processing order that is an order of the first data processing circuit 111, the second data processing circuit 112, the third data processing circuit 113, and the processor 14. This processing order applies to the examples hereinafter.

For example, the input port 151 of the first data processing circuit 111 is coupled to only the output port 153 of the second memory 122 through the connecting line 150, and the output port 152 is coupled to only the input port 154 of the first memory 121 through the separate connecting line 150. Therefore, the first data processing circuit 111 can access the first memory 121 when reading data waiting to be processed, and access the second memory 122 when writing processed data.

The second and third data processing circuits 112, 113 are connected so as to access the second and third memories 122, 123 respectively when reading data waiting to be processed, and access the third and fourth memories 123, 124 respectively when writing processed data. As described above, determined is a port to be communicated with the input port of which the destination output port is restricted without using the above described connection settings.

The input port 151 of the processor 14 is coupled to the input ports 154 of the first through fifth memories 121 to 124, 17 to ensure the certain degree of freedom of connection, but may be coupled to only the port 154 of the fourth memory 124. In addition, the third input port 156 is coupled to the output port 153 of the first through fifth memories 121 to 124, 17 for the same purpose, but may be coupled to only the port 153 of the first memory 121.

The switch circuit 15 of the present example reduces the electrical power consumption and decreases the footprint when the switch circuit 15 or the data processing device is produced as a chip compared to the switch circuit 15 illustrated in FIG. 14 because the number of the connecting lines 150 are smaller.

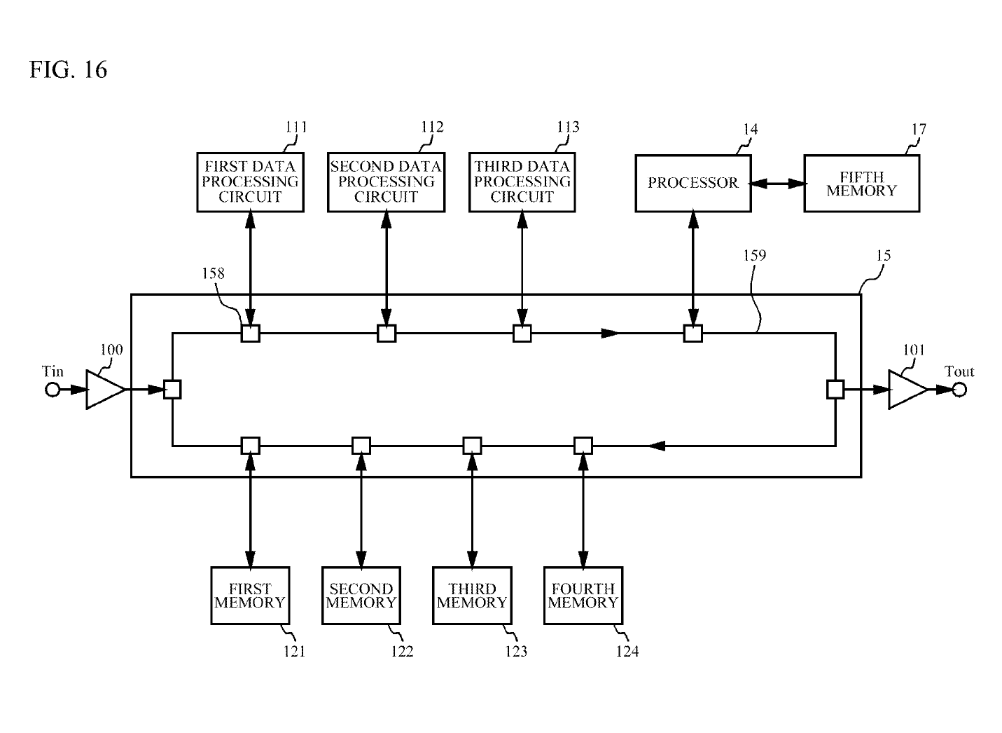

The configuration of the switch circuit 15 capable of achieving the reduction of the electrical power consumption and the footprint is not limited to the configuration illustrated in FIG. 15. FIG. 16 illustrates a connection configuration inside a ring switch.

The switch circuit 15 of the present example includes an annular transmission line 159 of which the transmit direction is a single direction and input/output ports 158 located along the annular transmission line 159. The input/output ports 158 are coupled to the input side buffer 100, the output side buffer 101, the first through third data processing circuits 111 to 113, the processor 14, and the first through fourth memories 121 to 124.

The input/output ports 158 coupled to the first through third data processing circuits 111 to 113 select a destination port according to individual connection settings as with the example of FIG. 14. The transmission side input/output port 158 gives port information about a to-be-communicated port according to the individual connection setting to a packet including one of or both the address and data input from a memory to be connected, and transmits it to the annular transmission line 159. The reception side input/output port 158 refers to the port information of the packet received through the annular transmission line 159, and outputs one of or both the address and data to a port to which it is to connect when the port information indicates the reception side input/output port 158 that received the packet. On the other hand, when the port information indicates a port other than the input/output port 158 that received the packet, the input/output port 158 transmits the packet to the adjoining input/output port 158 through the annular transmission line 159.

This makes the first through third data processing circuits 111 to 113 and the processor 14 access the first through fourth memories 121 to 124 through the input/output port 158 and the annular transmission line 159 when reading or writing data.

As described above, the switch circuit 15 of the present embodiment couples the first through third data processing circuits 111 to 113 and the processor 14 to the first through fourth memories 121 to 124 so that the first through third data processing circuits 111 to 113 and the processor 14 can access any of the first through fourth memories 121 to 124. Therefore, the degree of freedom of connection between the first through third data processing circuits 111 to 113 and the processor 14 and the first through fourth memories 121 to 124 is high, and the data processing order can be flexibly changed.

In addition, the switch circuit 15 of the present embodiment has a low number of the wirings and a low number of necessary switch gates compared to examples of FIG. 14 and FIG. 15, and thus can reduce the electrical power consumption and the footprint of a chip.

However, the switch circuits 15 illustrated in FIG. 14 and FIG. 15 have access time to the first through fourth memories 121 to 124 less than that of the switch circuit 15 of the present example. The following describes the reason.

The switch circuit 15 of the present example needs a certain amount of time to transmit data through a distance from a certain input/output port 158 to the adjoining input/output port 158, i.e. one hop. In addition, the annular transmission line 159 transmits a packet in only a single direction, and cannot transmit it in the opposite direction. This is because packets collide with each other and cause an error when the packets are transmitted in both directions.

Therefore, access time from the source input/output port 158 to the destination input/output port 158 depends on the number of hops. For example, when the data is transferred from the input side buffer 100 to the first memory 121, the access time corresponding to nine hops is required. In addition, when the first data processing circuit 111 writes data to the second memory 122, the access time corresponding to seven hops is required.

The number of hops is difficult to be reduced even though the input side buffer 100, the output side buffer 101, the first through third data processing circuits 111 to 113, the processor 14, and the first through fourth memories 121 to 124 are coupled to the annular transmission line 159 in consideration of the data processing order. This is because the transmit direction of the annular transmission line 159 is a single direction, and thus the number of hops for one of an address transmission process and a data reception process is reduced but the number of hops for the other one increases in a data reading process.

For example, when the first data processing circuit 111 reads data from the first memory 121, it requires the access time corresponding to ten hops, which is the sum of eight hops for transmitting the address to the first memory 121 and two hops for receiving data from the first memory 121. When the first data processing circuit 111 and the first memory 121 are coupled to the adjoining input/output ports 158, the number of hops for one of the address transmission process and the data reception process is one hop, but the number of hops for the other one is nine hops. As described above, the data reading process requires access time corresponding to the number of hops same as the total hop number of the annular transmission line 159 (ten hops in the present example) regardless of the connection location on the annular transmission line 159, i.e. the input/output port 158 to be connected.

Further, the number of hops affects waiting time to avoid the packet collision on the annular transmission line 159. That is to say, in the annular transmission line 159, when a first packet to be transmitted is present in the input/output port 158 in the transmission line through which a second packet is being transmitted, the first packet is made to wait. The fifth memory 17 is directly connected to the processor 14 without the switch circuit 15 to avoid the waiting time and make the program executed properly. Thus, data is transferred from the fifth memory 17 to the output side buffer 101 through the processor 14.

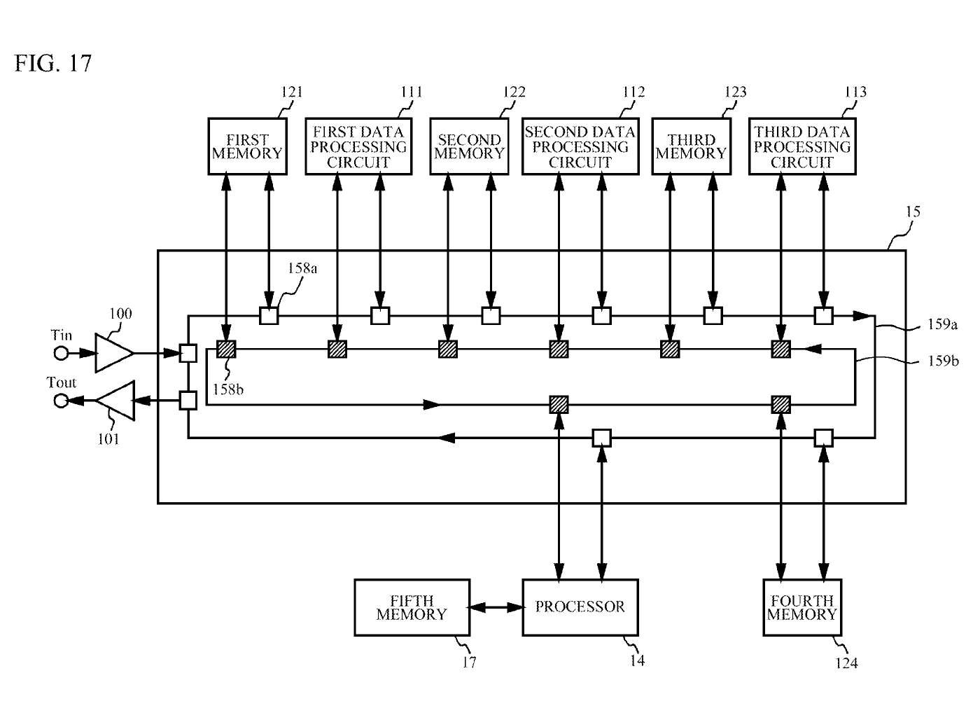

FIG. 17 illustrates an alternative connection configuration inside the ring switch. The switch circuit 15 of the present example includes two annular transmission lines 159a, 159b of which the transmit directions differ from each other, and input/output ports 158a, 158b located along the two annular transmission lines 159a, 159b respectively.

The two annular transmission lines 159a, 159b are coupled to buffers 100, 101, the first through third data processing circuits 111 to 113, the processor 14, and the first through fourth memories 121 to 124 through the input/output ports 158a, 158b respectively. The input/output ports 158a, 158b coupled to the first through third data processing circuits 111 to 113 select a destination port in the same manner as the above described input/output port 158.

The annular transmission line 159a transmits a packet in a clockwise direction in FIG. 17, while the annular transmission line 159b transmits a packet in an anticlockwise direction in FIG. 17. Therefore, the first through third data processing circuits 111 to 113 and the processor 14 can transmit the address through the annular transmission line 159b and receive data through the annular transmission line 159a when reading data. This reduces the number of hops in a process to read data.

In addition, as illustrated in FIG. 17, the buffers 100, 101, the first through third data processing circuits 111 to 113, the processor 14, and the first through fourth memories 121 to 124 are connected to positions on the two annular transmission lines 159a, 159b in accordance with the data processing order. For example, the first data processing circuit 111 and the first and second memories 121, 122 are connected to the adjoining input/output ports 158a. Thus, the first data processing circuit 111 can transmit the address by one hop through the annular transmission line 159b and receive data by one hop through the annular transmission line 159a when reading data. The number of hops of the second and third data processing circuits 112, 113 and the processor 14 is the same.

In addition, the first through third data processing circuits 111 to 113 and the processor 14 can transmit the address and data by one hop through the annular transmission line 159a when writing data. Further, the data transfer between the input side buffer 100 and the first memory 121 and the data transfer between the output side buffer 101 and the fifth memory 17 are performed by one hop through the annular transmission line 159a. As described above, the present example further reduces the number of hops by the connection considering the data processing order.

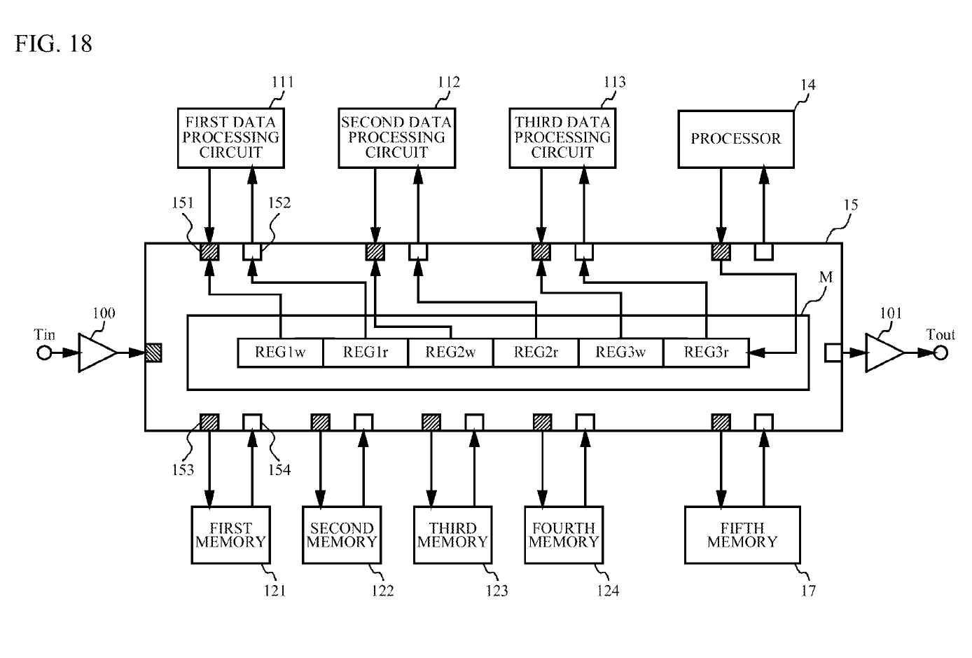

A description will next be given of a method of configuring connection settings for each port. FIG. 18 illustrates connection set registers in the switch. FIG. 18 uses the switch circuit 15 illustrated in FIG. 14 as an example.

The switch circuit 15 includes an internal memory M that stores connection set registers REG1w to REG3w, REG1r to REG3r. The connection set registers REG1w to REG3w indicate the output port 153 of a memory, out of the first through fourth memories 121 to 124, to be accessed by the first through third data processing circuits 111 to 113 when they writes data through the input ports 151. On the other hand, the connection set registers REG1r to REG3r indicate the input port 154 of a memory, out of the first through fourth memories 121 to 124, to be accessed by the first through third data processing circuits 111 to 113 when they read data through the output ports 152. The connection set registers REG1w to REG3w, REG1r to REG3r may be stored in a memory external to the switch circuit 15.

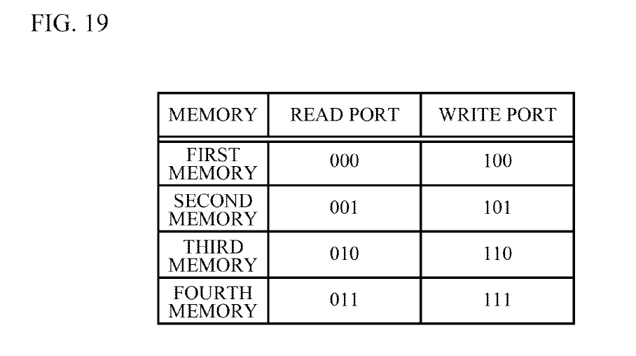

Identification numbers to identify the output ports 153 and the input ports 154 of the memories 121 to 124 are used for the connection settings. FIG. 19 illustrates identification numbers of the output ports 153 and the input ports 154 of the memories 121 to 124. In the table of FIG. 19, “MEMORY” indicates the first through fourth memories 121 to 124. “READ PORT” indicates identification numbers of the input ports 154 to which the memories 121 to 124, which are to be accessed when data is read, are coupled. “WRITE PORT” indicates identification numbers of the output ports 153 to which the memories 121 to 124, which are to be accessed when data is written, are coupled. The identification numbers are expressed in binary form in FIG. 19.

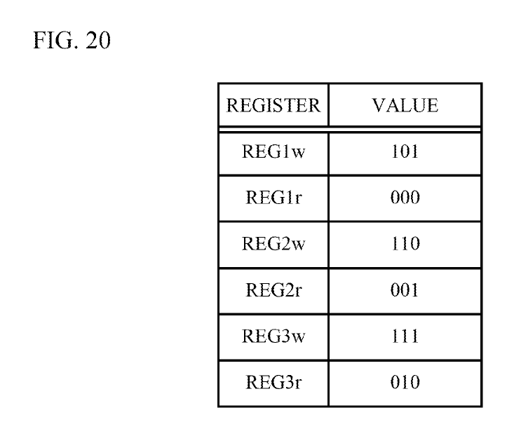

The contents of the connection set registers REG1w, REG1r, REG2w, REG2r, REG3w, REG3r are set by the processor 14 through their connection ports 151. FIG. 20 illustrates setting examples of the connection set registers REG1w, REG1r, REG2w, REG2r, REG3w, REG3r. The setting examples correspond the data processing order in the example of FIG. 5.

For example, the first data processing circuit 111 accesses the second memory 122 when writing data, and thus a value of “101”, which is the identification number of the output port 153 of the second memory 122, is set to the connection set register REG1w. In addition, the first data processing circuit 111 accesses the first memory 121 when reading data, and thus a value of “000”, which is the identification number of the input port 154 of the first memory 121, is set to the connection set register REG1r.

As described above, the switch circuit 15 selects a memory from the first through fourth memories 121 to 124 in accordance with the settings indicating a memory to be accessed out of the first through fourth memories 121 to 124 for each of the first through third data processing circuits 111 to 113. Therefore, the switch circuit 15 of the present example can flexibly change the data processing order by changing the settings.

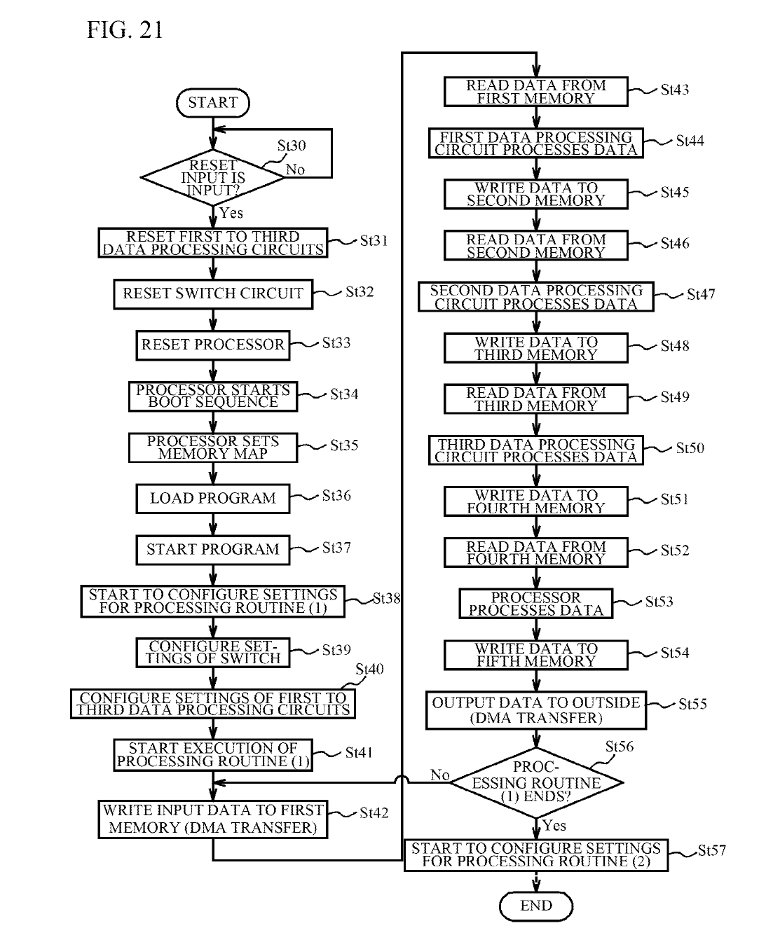

A description will next be given of a data processing method in accordance with the embodiment. FIG. 21 is a flowchart illustrating the data processing method in accordance with the embodiment. The above described data processing device is used in the data processing method.

The data processing device first determines whether a reset input is input from the outside or the inside (step St30). When the reset input is not input (step St30/No), the data processing device repeats the determination process of step St30.

On the other hand, when the reset input is input (step St30/Yes), the data processing device resets the first through third data processing circuits 111 to 113 (step St31). This process initializes settings of the first through third data processing circuits 111 to 113.

Then, the data processing device resets the switch circuit 15 (step St32). This process initializes various settings including the above described connection set registers REG1w to REG3w, REG1r to REG3r in the switch circuit 15.

The data processing device then resets the processor 14 (step St33). This makes the processor 14 start a boot sequence stored in the boot ROM (step St34).

When the boot sequence is started, the processor 14 sets a memory map (step St35). This forms the address space illustrated in FIG. 9 in the processor 14.

Then, the processor 14 loads a program from the boot ROM (step St36). This process stores the program in the above described program storage memory 13. Then, the processor 14 starts the program (step St37).

When the program is started, the processor 14 starts to configure the settings to execute a processing routine (1) (step St38). Each of processing routines (1) to (n) (n is a natural number) is a sequence of data processing by the first through third data processing circuits 111 to 113 and the processor 14, and has individual settings and an individual data processing order. The processor 14 configures the settings of the switch circuit 15 (step St39), and then configures the settings of the first through third data processing circuits 111 to 113 (step St40). This process configures the first through third data processing circuits 111 to 113 with predetermined settings, and configures the switch circuit 15 with predetermined settings such as the above described connection set registers REG1w to REG3w, REG1r to REG3r (see FIG. 20).

When the settings are completed, the processor 14 starts to execute the processing routine (1) (step St41). Assume that data is sequentially processed by the first data processing circuit 111, the second data processing circuit 112, the third data processing circuit 113, and the processor 14 in this order in the processing routine (1).

When the processing routine (1) is started, the DMA controller transfers data from the input side buffer 100 to the first memory 121 (step St42). Then, the first data processing circuit 111 reads data waiting to be processed from the first memory 121 (step St43). The first data processing circuit 111 then processes the data (step St44), and writes the processed data to the second memory 122 (step St45).

Then, the second data processing circuit 112 reads data waiting to be processed from the second memory 122 (step St46). Then, the second data processing circuit 112 processes the data (step St47), and writes the processed data to the third memory 123 (step St48).

Then the third data processing circuit 113 reads data waiting to be processed from the third memory 123 (step St49). The third data processing circuit 113 then processes the data (step St50), and writes the processed data to the fourth memory 124 (step St51).

Then, the processor 14 reads data waiting to be processed from the fourth memory 124 (step St52). The processor 14 then processes the data (step St53), and writes the processed data to the fifth memory 17 (step St54). The procedures of the data processing are as described with reference to FIG. 7 and FIG. 10.

The data on which all the processes are performed is transferred from the fifth memory 17 to the output side buffer 101 by the DMA controller and output to the outside (step St55). The processor 14 then determines whether the processing routine (1) is ended (step St56). The determination is performed by referring to the presence or absence of the error in the data processing.

When the processing routine (1) does not end (step St56/No), the process is repeated from step 42. On the other hand, when the processing routine (1) ends (step St56/Yes), the processor 14 starts to configure the settings to execute the processing routine (2) (step St57). In the process thereafter, the process same as the process from step 38 to step St56 is repeated in accordance with the data processing order with respect to each processing routine, and when all the processing routines end, the program operation ends. The data processing is performed as described above.

As described above, the data processing method of the embodiment sequentially processes data stored in the memories 121 to 124, 17 by the first through third data processing circuits 111 to 113 and the processor 14. A common memory is selected from the memories 121 to 124, 17 as a memory to be accessed when one of two, which successively process data, of the first through third data processing circuits 111 to 113 and the processor 14 writes the data and the other one reads data.

Therefore, the data processing method of the embodiment can reduce the number of times of the data transfer processing by the DMA controller as the above described data processing device can. The present embodiment describes the data processing method using the data processing device illustrated in FIG. 7, but a data processing method using the data processing device illustrated in FIG. 5 has the same advantage.

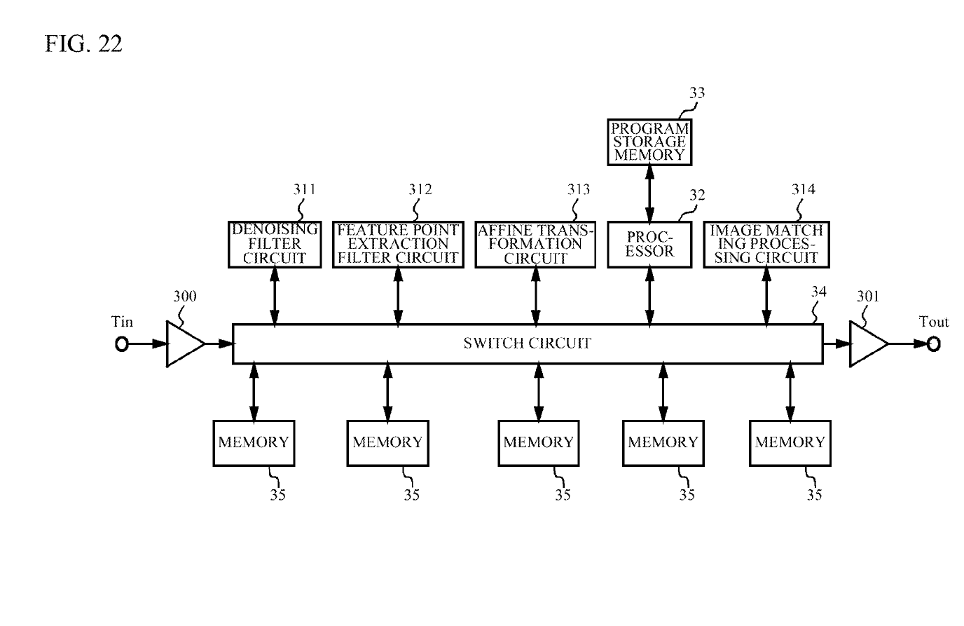

The above described data processing device and data processing method is used in an image recognition device for example. FIG. 22 is a configuration diagram illustrating a configuration of an image recognition device.

The image recognition device includes a denoising filter circuit 311, a feature point extraction filter circuit 312, an affine transformation circuit 313, and an image matching processing circuit 314. The image recognition device further includes a processor 32, a program storage memory 33, a switch circuit 34, an input side buffer 300, an output side buffer 301, and memories 35.

The denoising filter circuit 311, the feature point extraction filter circuit 312, the affine transformation circuit 313, and the image matching processing circuit 314 correspond to the above described data processing circuits 111 to 113 respectively. The processor 32, the program storage memory 33, and the switch circuit 34 correspond to the processor 14, the program storage memory 13, and the switch circuit 15 described above, respectively. The input side buffer 300, the output side buffer 301, and the memories 35 correspond to the input side buffer 100, the output side buffer 101, and the first through fifth memories 121 to 124, 17 respectively.

In the present example, data to be processed is image data with VGA (Video Graphics Array) size (640×480 (pixels)), and the frame rate thereof is, for example, 10 to 30 (fps).

The image data is input from the input terminal Tin to the input side buffer 300, and sequentially passed among the functional elements 311 to 314 and the processor 32 through the memories 35. At this point, the functional elements 311 to 314 and the processor 32 access one of the memories 35 through the switch circuit 34 when reading or writing data. An image recognition result on which all the processes are performed is input to the output side buffer 301 through the switch circuit 34, and output to the outside of the device from the output terminal Tout.

The denoising filter circuit 311 performs, for example, a median filtering process to remove noise from the image data, and smooths the image. The feature point extraction filter circuit 312 then performs, for example, 3×3, 5×5, or 7×7 filter matrix operation to the image data from which the noise is removed to detect the edge portion of the image and generate an edge image. This allows the extraction of the feature point of the image, which is used in an image recognition algorithm executed by the processor 32 and the image matching processing circuit 314.

The affine transformation circuit 313 then performs at least one of an enlarging process, a reducing process, and a rotating process to the image of the image data of which the feature point is extracted to transform the image into the form suitable for the above described image recognition algorithm. Whether to execute the transform process may be determined as necessary.

The processor 32 and the image matching processing circuit 314 then execute the image recognition algorithm to the image data to which the enlarging process and the like are executed. The image recognition algorithm is a process to detect a person, a face, or a vehicle contained in the image in accordance with the objectives.

The image matching processing circuit 314 performs a process that needs a relatively high processing speed of the image recognition algorithm. The processor 32 activates the image matching processing circuit 314 and performs the process as needed during the execution of the image recognition algorithm. Then, the image recognition result to which the image recognition processing is completed is output to the outside through the output terminal Tout.

The functional elements 311 to 314 process the image data by the different sizes. For example, the denoising filter circuit 311 and the feature point extraction filter circuit 312 process one image data by the line number (one line includes 640 (pixels) in a case of VGA size) in accordance with the size of the filter matrix used by the feature point extraction filter circuit 312. For example, when the size of the filter matrix is 3×3, the line number is 3. In addition, the affine transformation circuit 313 processes the image data by the one screen.

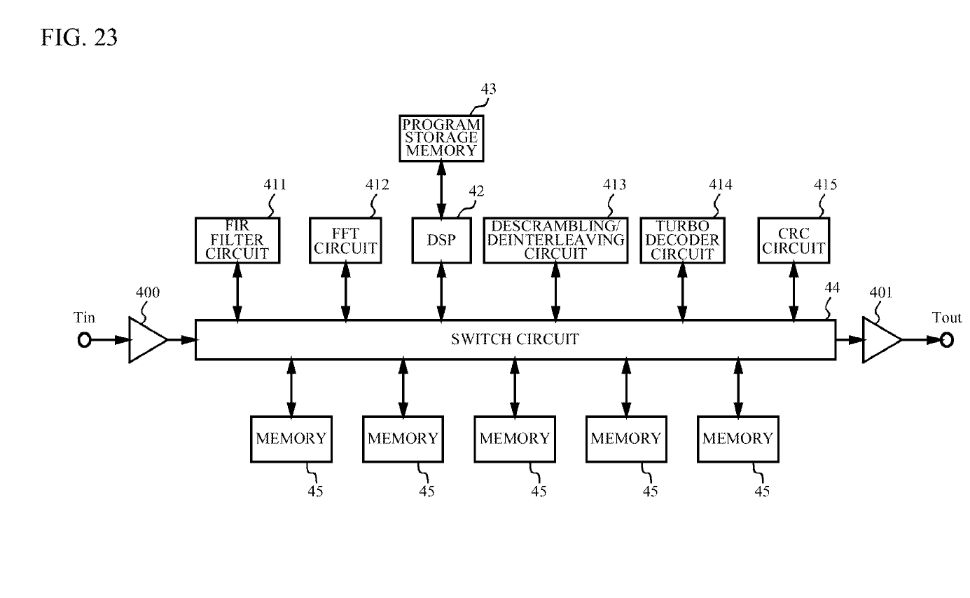

A description will next be given of an example applying the above described data processing device and the data processing method to a radio communication apparatus. FIG. 23 is a configuration diagram illustrating a configuration of the radio communication apparatus. More specifically, FIG. 23 illustrates a configuration of a receive unit of the radio communication apparatus employing LTE (Long Term Evolution) technology.

The radio communication apparatus includes an FIR (Finite Impulse Response) filter circuit 411 and an FFT (Fast Fourier Transform) circuit 412. In addition, the radio communication apparatus includes a descrambling/deinterleaving circuit 413, a turbo decoder circuit 414, and a CRC (Cyclic Redundancy Check) circuit 415. The radio communication apparatus further includes a DSP 42, a program storage memory 43, a switch circuit 44, an input side buffer 400, an output side buffer 401, and memories 45.

The FIR filter circuit 411, the FFT circuit 412, the descrambling/deinterleaving circuit 413, the turbo decoder circuit 414, and the CRC circuit 415 correspond to the above described data processing circuit 111 to 113 respectively. The DSP 42, the program storage memory 43, and the switch circuit 44 correspond to the processor 14, the program storage memory 13, and the switch circuit 15 described above respectively. The input side buffer 400, the output side buffer 401, and the memories 45 correspond to the input side buffer 100, the output side buffer 101, and the first through fifth memories 121 to 124, 17.

In the present example, data to be processed is communication data of a signal modulated by Orthogonal Frequency Division Multiplexing (OFDM). The radio communication apparatus demodulates the communication data.

The communication data is input from the input terminal Tin to the input side buffer 400, and sequentially passed among the functional element 411 to 415 and the DSP 42 through the memories 45. At this point, the functional elements 411 to 415 and the DSP 42 access one of the memories 45 through the switch circuit 44 when reading or writing data. The communication data on which all the processes are performed is input to the output side buffer 401 through the switch circuit 44, and output to the outside of the device from the output terminal Tout.

The FIR filter circuit 411 filters the communication data with an FIR filter, and extracts a signal component of an effective band. The FFT circuit 412 FFT-processes the extracted signal component of the effective band.

The DSP 42 then demodulates the signal to which the FFT processing is completed. The demodulation processing is performed by performing channel estimation based on a reference signal mapped with the received signal and using the value obtained by the channel estimation.

The descrambling/deinterleaving circuit 413 descrambles and deinterleaves the demodulated signal. The turbo decoder circuit 414 then decodes a turbo-coded part of the descrambled and deinterleaved signal. The CRC circuit 415 then examines the data of the decoded signal in accordance with the CRC method. When there is no error in the communication data as a result of the examination, the communication data is output to the outside of the device through the output terminal Tout. On the other hand, when there is an error in the communication data, the radio communication apparatus discards the communication data, and requests the transmission device to re-send the signal. As described above, the data processing circuit of the embodiment is applied to various types of devices.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A data processing device comprising:
storing units, each configured to store data;
data processing units configured to sequentially process the data; and
a switch unit configured to couple the storing units to the data processing units, and select a common storing unit from the storing units as a storing unit to be accessed when a first data processing unit of two data processing units out of the data processing units writes the data and a second data processing unit of the two data processing units reads the data, the two data processing units successively processing the data.

2. The data processing device according to claim 1, wherein
the switch unit includes two annular transmission lines of which transmit directions differ from each other, and
each of the two annular transmission lines is coupled to the storing units and the data processing units.

3. The data processing device according to claim 2, wherein
the storing units and the data processing units are coupled to positions on the two annular transmission lines in accordance with an order in which the data is processed.

4. The data processing device according to claim 1, wherein
the switch unit couples the storing units to the data processing units so that each of the data processing units can access any of the storing units.

5. The data processing device according to claim 2, wherein
the switch unit selects a storing unit from the storing units in accordance with a setting indicating a storing unit to be accessed for each of the data processing units, the storing unit to be accessed being out of the storing units.

6. The data processing device according to claim 1, wherein
the switch unit couples the storing units to the data processing units so that each of the data processing units can access a storing unit to be accessed out of the storing units in accordance with an order in which the data is processed.

7. The data processing device according to claim 1, wherein
each of the storing units includes two areas, and
writing of the data to a first area of the two areas and reading of the data from a second area of the two areas and writing of the data to the second area and reading of the data from the first area are alternated at time intervals.

8. The data processing device according to claim 1, wherein
at least one of the data processing units is a processor, and
at least one of the storing units has a storage area allocated to an address space of the processor.

9. A data processing method comprising:
selecting a common storing unit from storing units as a storing unit to be accessed when a first data processing unit of two data processing units out of data processing units writes data and a second data processing unit of the two data processing units reads the data, the data processing units sequentially processing the data stored in the storing units, and the two data processing units successively processing the data.

10. The data processing method according to claim 9, wherein
each of the storing units includes two areas, and
writing of the data to a first area of the two areas and reading of the data from a second area of the two areas and writing of the data to the second area and reading of the data from the first area are alternated at time intervals.

11. The data processing method according to claim 9, wherein
at least one of the data processing units is a processor, and
at least one of the storing units has a storage area allocated to an address space of the processor.
